(19) United States
(12) Patent Application Publication
(10) Pub. No.: US 2013/0130383 A1
(43) Pub. Date: May 23, 2013

(54) ULTRAHIGH SURFACE AREA SUPPORTS FOR NANOMATERIAL ATTACHMENT

(71) Applicant: Wright State University, Dayton, OH (US)

(72) Inventor: Sharmila M. Mukhopadhyay, Beavercreek, OH (US)

(73) Assignee: WRIGHT STATE UNIVERSITY, Dayton, OH (US)

(21) Appl. No.: 13/681,752

(22) Filed: Nov. 20, 2012

Related U.S. Application Data
(60) Provisional application No. 61/563,152, filed on Nov. 23, 2011.

(51) Int. Cl. C09D 5/00

(52) U.S. Cl. CPC C09D 5/00; Y10S 977/701; Y10S 977/715; Y10S 977/89; B82Y 40/00
USPC 435/395; 502/300; 502/100; 427/180; 427/569; 427/201; 428/143; 210/506; 204/400; 204/431; 977/701; 977/715; 977/890

(57) ABSTRACT

The present invention is directed to a hierarchical structure characterized by ultrahigh surface area comprising: a solid substrate; an intermediate layer; and at least one plurality of nanoscale attachments that are strongly bonded to the intermediate layer. Also disclosed is a method of fabricating a hierarchical structure comprising: selecting and preparing a parent substrate, wherein the preparing may optionally include cleaning or activation; modifying the substrate surface to form an intermediate layer; attaching at least one plurality of nanoscale attachments, wherein the nanoscale attachments are selected from nanotubes, nanoparticles, or combinations thereof, onto the intermediate layer; optionally attaching a second plurality of nanoscale attachments, wherein the nanoscale attachments are selected from nanotubes, nanoparticles, or combinations thereof, onto the first plurality of nanoscale attachments and intermediate layer.

### CROSS-REFERENCE TO RELATED APPLICATION

This application claims the benefit of U.S. Provisional Application No. 61/563,152 filed Nov. 23, 2011.

### TECHNICAL FIELD

The present invention is directed to a hierarchical structure wherein a conventional compact or porous solid substrate is modified and further includes nanoscale attachments that significantly increase its surface area, and provide advantages in surface-related applications such as catalysis, sensing, bioactivity, charge and gas storage, chemical, thermal and mechanical interactions.

### BACKGROUND

Prior patents have taught that carbon nanotubes and/or nanometer-scale metals can be grown using various methods. U.S. Pat. No. 7,148,512 discloses carbon nanotubes having nanometer-scale silver filling embedded on a silver colloid base to create a thermal interface for heat conduction in electronic components such as semiconductor chips. U.S. Pat. No. 8,207,658 discloses carbon nanotubes may be grown on metal surfaces, where the metal surface is preferably a nonmagnetic metal alloy, such as INCONEL 600. U.S. Pat. No. 7,438,885 teaches carbon nanotubes filled and decorated with palladium nanoparticles, wherein the synthesis involves arc-discharge technique with palladium chloride solution at temperatures greater than 3000° C. The palladium is ionized into nanoparticles and the graphite electrodes generate layers of graphene (carbon) which roll away from the anode and encapsulate or entrap the Pd-nanoparticles for use potentially as a gas sensor or as a means for hydrogen storage. U.S. Pat. No. 8,052,951 discloses bulk support media such as quartz fibers or particles, carbon fibers, or activated carbon, having carbon nanotubes formed therewith adjacent to metal catalyst species. Methods employ metal salt solutions such as iron chloride, aluminum chloride, or nickel chloride. The carbon nanotubes may be separated from the bulk support media and the metal catalyst species by using concentrated acids to oxidize the media and catalyst species.

Previously, nanomaterials such as nanotubes and nanoparticles that are not grown on metals or silicon wafers are either in the form of loose dust or entrapped in the pores. The resultant structures were then comprised of loosely combined units that cannot effectively restrain nanoparticles to prevent loss or leaching in service conditions.

The present invention addresses these challenges by strongly anchoring nanoscale attachments onto surfaces of larger solids, thereby ensuring that the nanoscale attachments do not coalesce during transportation and storage and further ensuring they are not lost to the environment, thus preventing detrimental effects to the environment. The present invention synthesizes structures wherein attachment between nanoparticles and the parent substrate, including porous substrates, are at least as strong as the substrate itself.

### SUMMARY OF THE INVENTION

In at least one embodiment of the invention, a hierarchical structure characterized by ultrahigh surface area comprises: a solid substrate; an intermediate layer; and at least one plurality of nanoscale attachments that are strongly bonded to the intermediate layer.

In one or more embodiments, the hierarchical structure further includes a substrate surface, wherein at least one aspect of the substrate surface is modified to enhance bonding.

In one or more embodiments, the intermediate layer of the hierarchical structure is formed at the substrate surface.

In one or more embodiments, the hierarchical structure is characterized by a specific surface area of at least about 100 times the specific surface area of the solid substrate.

In one or more embodiments, the solid substrate of the hierarchical structure is compact or porous.

In one or more embodiments, the porous substrate comprises fibers, foams, sponges, fabric, paper, or combinations thereof.

In one or more embodiments, the substrate is inorganic or organic.

In one or more embodiments, the substrate comprises carbon, oxides, ceramics, glasses, polymers, or combinations thereof.

In one or more embodiments, the porous substrate is derived from plant, animal, or geological sources.

In one or more embodiments, the nanoscale attachments comprise nanotubes, nanoparticles, or combinations thereof.

In one or more embodiments, the nanotubes are cylindrical structures with diameters ranging from about 10 to about 50 nm and aspect ratios ranging from about 10 to about 100,000.

In one or more embodiments, the nanotubes are useful for guiding cell growth and for efficient thermal and electrical transport with the surrounding media.

In one or more embodiments, the nanoparticles comprise metals or compounds with surface-active properties suitable for catalysis, sensing, bioactivity, or antibacterial effect.

In one or more embodiments, the nanoparticles have a controlled particle size distribution from about 3 nm to about 8 nm.

In one or more embodiments, the nanoparticles have a broad particle size distribution from about 5 nm to about 100 nm.

In one or more embodiments, the nanoparticles are elements, compounds, or combinations thereof.

In one or more embodiments, the hierarchical structure is used for water purification.

In one or more embodiments, the hierarchical structure is used for sensing and remedial treatment of gases or fluids.

In one or more embodiments, a method of fabricating a hierarchical structure comprising: selecting and preparing a parent substrate, wherein the preparing may optionally include cleaning or activation; modifying the substrate surface to form an intermediate layer; attaching at least one plurality of nanoscale attachments, wherein the nanoscale attachments are selected from nanotubes, nanoparticles, or combinations thereof, onto the intermediate layer; optionally attaching a second plurality of nanoscale attachments, wherein the nanoscale attachments are selected from nanotubes, nanoparticles, or combinations thereof, onto the first plurality of nanoscale attachments and intermediate layer; wherein the steps of forming the intermediate layer and attaching the nanoscale attachments use one or more surface modification techniques selected from the group (a) wet chemistry, (b) chemical vapor deposition, (c) plasma deposition, (d) atomic layer deposition, (e) physical vapor deposition, (f) controlled environment heating, or a combination thereof; and optionally heating in a controlled environment.

### BRIEF DESCRIPTION OF THE DRAWINGS

Advantages of the present invention will become better understood with regard to the following description, appended claims, and accompanying drawings wherein:

FIG. 1 is a schematic diagram of the hierarchical structure of the invention.

FIG. 2 is a flow chart detailing the method of fabricating the hierarchical structure of the invention.

FIG. 3 includes SEM micrographs of carbon nanotubes attached on commercial cellular foam using one of the processes of the invention: (a) low magnification image, (b) higher magnification image of ligaments, and (c) image showing dense growth possible in some areas even inside a pore.

FIG. 4 includes SEM micrographs of carbon nanotubes attached on commercial reticulated carbon foam using the same process at (a) 50× magnification, (b) 1,000× magnification, and (c) 5,000× magnification.

FIG. 5 includes a schematic profile of the surface of a pore showing that compared to a normal surface (a), the hierarchical surface with nanoscale attachments can accommodate significantly larger number of surface active nanoparticles as shown in (b). The increase in particle density can be controlled by density and length of nanotubes grafted on the surface.

FIG. 6 shows Electron Microscope images of Pd-NP structures in this invention.

FIG. 7 includes SEM micrographs of silver nanoparticles attached to nanotubes that have been grafted on microcellular foam specimens.

FIG. 8 is an example of the particle distribution obtained for Ag nanoparticles obtained at two reduction temperatures.

FIG. 9 shows how the hierarchical structures of the invention are effective in bacteria removal from water. The dark spots are bacterial colonies formed in lake water when (a) untreated (b) treated with 4 mm×4 mm×2 mm samples of AgNP-CNT/Foam (as shown in FIG. 7).

FIGS. 10a and 10b show schematics of how the nanoparticle-nanotube activated porous material can be used to remove contaminants from liquids.

### DETAILED DESCRIPTION OF PREFERRED EMBODIMENTS

Embodiments of the present invention are based on the discovery of a hierarchical structure formed on a substrate that increases the specific surface area of the starting substrate by several orders of magnitude. The hierarchical structure of the present invention is referred to as ultrahigh surface area in that the surface area of the structure is at least about 100 times or more compared with that of the original substrate. The structure comprises a solid substrate and a plurality of nanoscale attachments, wherein the substrate has been modified to ensure durability of the nanoscale attachments. The modified substrate includes an intermediate layer onto which at least one plurality of nanoscale attachments is attached. While conventional wisdom may suggest that the surface area of a solid substrate can be increased by other means such as porosity, there is a practical limit to such increase, because porosity makes the solid structurally weaker. This invention provides hierarchical structures wherein nanotubes are attached on the solid, hence providing orders of magnitude increase in surface area without compromising the strength or structural integrity, resulting in better performance while maintaining robustness.

Multi-scale hierarchical structures of the present invention are solids that contain components characterized by different length scales. For example, nanoscale attachments according to the present invention are strongly tethered to solid substrates, which are not characterized as nanoscale, such that the nanostructures do not detach from the parent substrate under service conditions. These structures are further suitable for anchoring nanoparticles, such as nanometals having known surface-active properties useful in non-limiting examples such as catalysis, sensing, hydrogen storage, electrochemical activity, cell interaction, or antimicrobial behavior.

Previously, nanomaterials with surfaces exposed to service environment have been mainly in the form of loose particles or dust that gets leached or dispersed into the environment (i.e. air, water, soil, or body) where used; thereby making nanomaterials expensive and risky to use. For example, previous investigators have entrapped nanoparticles in porous materials; however, the bonding between the nanotubes/nanoparticles has not been strong enough to effectively restrain nanoparticles to prevent loss or leaching.

Therefore, in prior art, such nanoparticles having beneficial properties could not be used practically due to problems of retention of nanoparticles onto structure substrates leading to problems such as (i) loose nanoparticles clustering together during transportation and/or storage, (ii) nanoparticles escaping into the environment thus requiring replenishment, i.e. redeposition, (iii) nanoparticles escaping into the environment thus causing potential detrimental effects on the ecosystem or other environmental concerns; and (iv) nanoparticles escaping into the environment thus causing unknown health risks to population due to nanoparticle exposure.

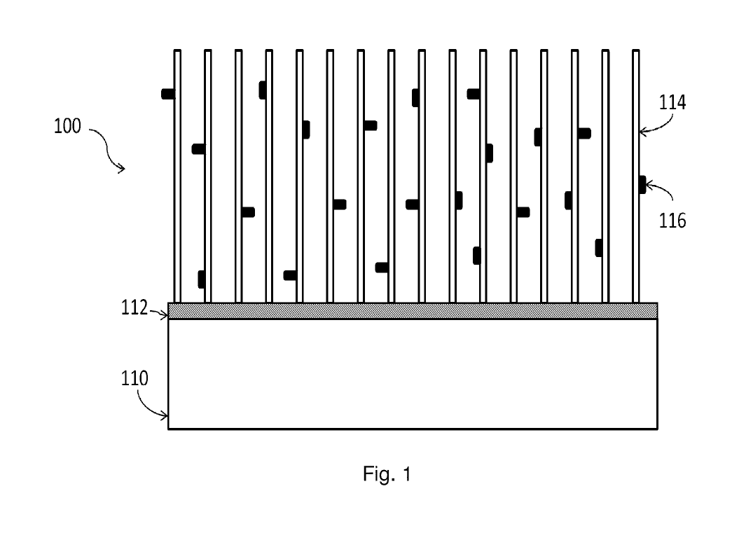

FIG. 1 is a schematic diagram of the hierarchical structures according to the concepts of the present invention. Hierarchical structure 100 is comprised of a solid substrate 110. The substrate is modified or coated with chemicals, ions, plasma and/or heat to form an intermediate layer 112. To form the intermediate layer, one or more of the following non-limiting techniques may be used selected from the group (a) wet chemistry, (b) chemical vapor deposition, (c) plasma deposition, (d) atomic layer deposition, (e) physical vapor deposition, (f) controlled environment heating, or combinations thereof.

Further, nanoscale attachments such as nanotubes 114, nanoparticles 116, or combinations thereof are then deposited, or grown onto the intermediate layer 112 using liquid phase and/or vapor phase techniques selected from the group (a) wet chemistry, (b) chemical vapor deposition, (c) plasma deposition, (d) atomic layer deposition, (e) physical vapor deposition, (f) controlled environment heating, or combinations thereof.

Different types of solids have been developed over the years for use in catalysts, sensors, filters, and sieves. Substrates 110 suitable for use in the present invention include both compact and porous solids. In at least one embodiment of the invention, the substrate may be inorganic or organic. The substrate of the invention may be further characterized as comprising of simple solids, fibers, foams, sponges, fabric, and/or paper. Substrates for use in one or more embodiments of the invention may comprise carbon, oxides, polymers, or combinations or composites thereof. The substrate geometry may be simple or complex. Several grades of such material are already available from a wide range of commercial sources. The commercial substrates can be advantageously engineered in the present invention to result in configurations such as nanoparticles directly anchored to relatively flat or uneven porous solids; or alternatively, nanoparticles attached onto nanotubes that are tethered to the substrate; or combinations thereof.

In at least one embodiment of the present invention, the substrate is highly oriented pyrolytic graphite (HOPG). In yet another at least one embodiment of the present invention, the base structure is microcellular or reticulate foam, an open cell structure, with porosities ranging from about 68% to about 94% and further characterized as having a high surface area.

Nanomaterials, materials having one or more dimensions less than 100 nm, are known for many beneficial properties. Nanomaterials may be referred to interchangeably herein as nanoscale attachments or nanoscale components. In at least one embodiment of the present invention, advantages arise from the increased specific surface area (SSA) of the solid without loss in mechanical integrity. Applications using structures comprising nanoscale attachments according to the present invention in at least one embodiment are directed to surface activity applications including: (i) catalysts for environmental purification using non-limiting examples of nanomaterials such as Pd, and Ni; (ii) electrochemical activities such as charge storage and sensing using non-limiting examples of nanomaterials such as Pd, Ag; (iii) hydrogen storage and transport activities using carbon nanotubes (CNT) and Pd, (iv) antimicrobial activity using non-limiting examples of nanomaterials such as Ag; and (v) biological interactions such as cell scaffolding with CNT and/or anti-bacterial coatings using silver nanoparticles. Using the advantageous structures comprising nanoscale attachments according to the present invention can result in time savings due to increased activity, space and weight savings due to miniaturization of the active device, and cost savings, especially for those devices utilizing precious metals.

In at least one embodiment of the present invention, the nanoscale attachments are nanotubes 114. Nanotubes according to the present invention may be carbon nanotubes (CNT). In at least one embodiment of the present invention, CNTs are grafted onto the base support. In yet another at least one embodiment of the present invention, the nanoscale attachments are nanoparticles 116, which may include non-limiting examples such as iron nanoparticles (also referred to as FeNP) or palladium nanoparticles (PdNP) or silver nanoparticles (AgNP). In at least one embodiment of the present invention, the nanoscale attachments include nanoparticles attached onto nanotubes. In yet another embodiment of the invention, the nanoscale attachments have been further modified with chemicals or ions for fluid permeation and wettability.

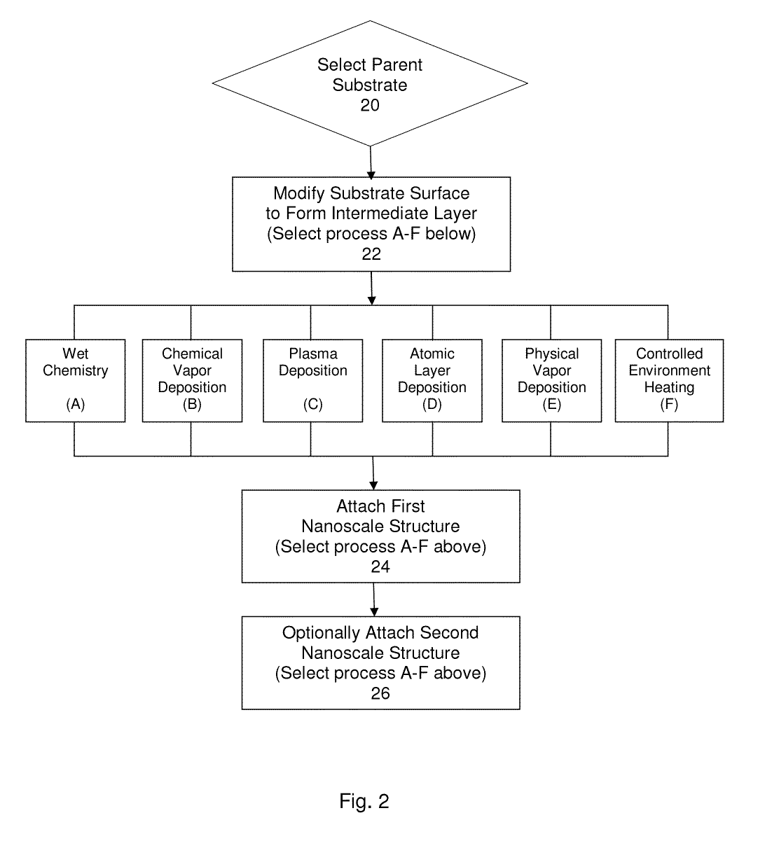

In at least one embodiment of the present invention, the nanoscale component(s) of selected metals are attached to the substrate, wherein the substrate has been first modified at the surface to include an intermediate layer. The hierarchical structure of the present invention is, created by attachment of nanotubes onto commercially available substrates, which have been modified to include an intermediate layer. Strong attachment of the nanotubes and/or nanoparticles is achieved by modifying the substrate to form an intermediate layer prior to attaching at least one plurality of nanoscale components. Examples of surface preparation/modification techniques according to the present invention include, but are not limited to: cleaning and activation with chemical reagents, solvents, ions or plasma; and deposition of nanoscale reactive layer by use of liquid precursors, molecular layering (atomic layer deposition), plasma deposition, chemical vapor deposition (CVD), or catalyst chemical vapor deposition (CCVD) methods. In one or more embodiments of the present invention, surface modification techniques are selected from the group (a) wet chemistry, (b) chemical vapor deposition, (c) plasma deposition, (d) atomic layer deposition, (e) physical vapor deposition, (f) controlled environment heating, or a combination thereof as shown in FIG. 2. Technique selection is tailored to the individual application while also considering cost and quantity of the final commercial product. The surface preparation/attachment techniques according to the present invention result in the formation of an intermediate layer 112.

In at least one embodiment of the present invention, the intermediate layer is a nanometer-scale silica, also referred to as silicon dioxide or SiO₂, layer using microwave plasma deposition (MPD) of hexa-methyl-disiloxane (HMDSO) in O₂. Deposition of the oxide coating onto the substrate is accomplished in three stages: (stage 1) introducing O₂ gas in to the microwave plasma chamber; (stage 2) subsequently flowing O₂ with HMDSO at increased microwave power to deposit oxide on the substrate surface; and (stage 3) introducing O₂ carrier gas into the chamber to stabilize the oxide coating at lower microwave power.

Silica thickness is controlled by varying the coating time for stage 2 during MPD. The coating begins to manifest itself first as ‘island’ growth with heights of about 3 to 5 nm. The islands densely cover the surface of the substrate after about 30 seconds, and eventually coalesce by about 1 minute to form a uniform layer thickness of about 4 nm, with a surface roughness of less than 1 nm. The silica chemically bonds to the surface of the graphite substrate to form an interface of Si—C bonds. The intermediate layer of this particular embodiment, as defined herein, includes the Si—C bonds at the interface and silica deposited thereon.

After the intermediate oxide coating, or silica layer deposition as in this example, the sample is transferred to the chemical vapor deposition (CVD) reactor for nanotube deposition by the floating catalyst method using a mixture of ferrocene and xylene. Longer CVD reaction times are possible and result in further CNT growth and potential entanglement, which may be desired for some applications.

In at least one embodiment of the invention, the hierarchical structure including the substrate, the intermediate layer (oxide coating), and nanotubes deposited thereon are further treated in order to include a second plurality of nanoscale attachments, for example nanoparticles, adhered onto the nanotubes. The nanoparticles, which may be gold, palladium, or silver for example, are formed by coating the hierarchical structure with precursor solution, reducing the metal containing precursors and subsequently heat treating in a controlled environment. These nanoparticles have potential to act as catalysts, sensors, absorbents, or anti-microbial agents.

Similar or improved success may also be obtained by functionalizing the substrate to form an intermediate layer using one or more of the following techniques: (i) oxide coating using commercial liquid precursors followed by controlled thermal treatments (ii) ultrathin coating of oxides such as aluminum oxide or silicon dioxide using atomic layer deposition, (iii) intermediate layer of oxide using chemical vapor deposition (CVD). There are alternative means to prepare or modify the substrate surface in the practice of the present invention. For some substrates, as in one or more embodiments, the intermediate layer may be defined alternatively as an acid etched substrate surface.

Attachment of nanoscale components to the intermediate layer of hierarchical structures according to the present invention increases the available surface area of the overall solid by several orders of magnitude. This increased surface area can be used in multiple ways. One possibility is to use the bare nanotubes as “nano-radiators” that allow increased dissipation of heat or electric current across the surface. Another possibility is to use these hierarchical structures as a composite core material, or alternatively, as a template or scaffolding for cell growth. In one or more embodiments, the increased surface area is utilized to support nanoparticles that can act as catalysts, sensors, or absorbents.

In at least one embodiment of this invention, the substrate with nanotubes, nanoparticles, or combinations thereof deposited thereon are further functionalized for increased wettability or infiltration with other materials such as fluids, resins or energy storage (phase change) materials.

Strong attachment in a testing environment is defined such that the nanoscale attachments do not get detached from the substrate before the substrate itself is internally damaged through the testing. As a practical matter, strong attachment ensures that desired performance of the hierarchical structure is met under use conditions.

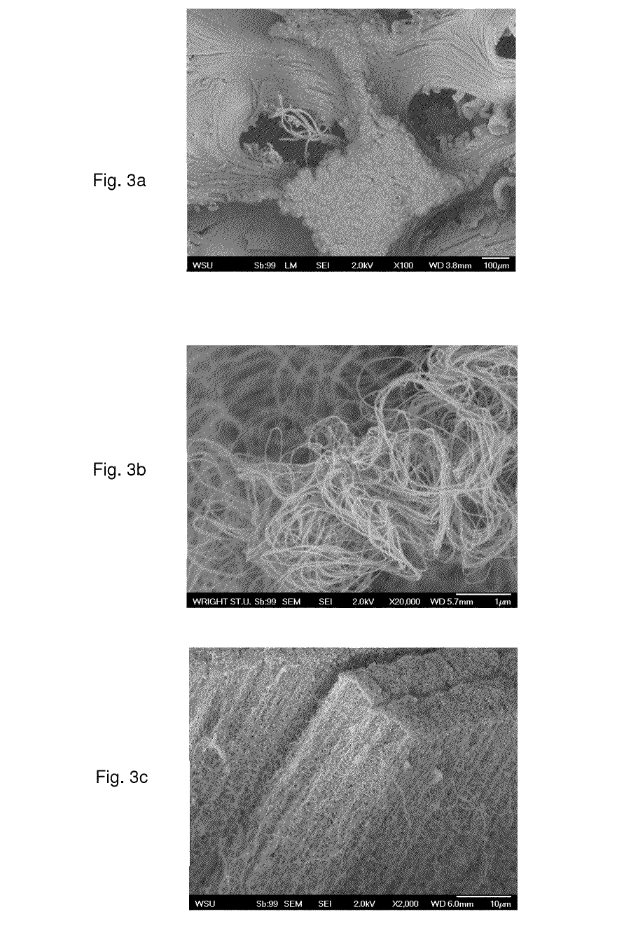

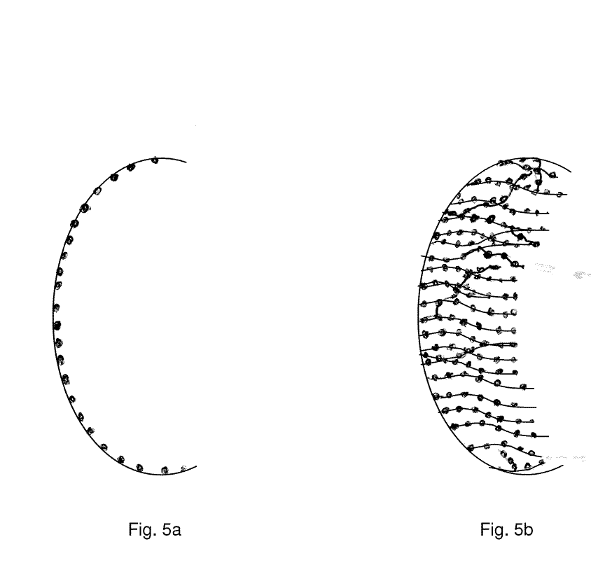

The initial success of nanotube and nanoparticle attachment is observed by imaging with scanning electron microscopy (SEM), as seen in FIGS. 3, 4, 6 and 7. Measuring the average length, density and diameter of nanotubes provides an estimate of the increase in surface area. This number along with a microscopic measurement of number of nanoparticles per unit length of nanotube provides an estimate of the density of metal nanoparticles that can be packed on the surface. In one or more embodiments, over 7×10¹² nanoparticles/cm² (or 70,000 nanoparticles per square micron) could be accommodated on the surface using nanotube attachment as in FIG. 5b compared to 3×10¹⁰ nanoparticles/cm² (or 300 nanoparticles per square micron) on untreated surface similar to FIG. 5a.

To make direct determination of the specific surface area (SSA) of the substrate, the Brunauer-Emmett-Teller (BET) technique with nitrogen may be used. In one or more embodiments, the ultrahigh surface area hierarchical structures of the present invention are characterized by an increase in surface area by at least about 100-fold. In other words, the hierarchical structure has a surface area about 100 times that of the original substrate. In other embodiments, the ultrahigh hierarchical structure is characterized by having a specific surface area that is from at least about 100 to about 1000 times (10,000-100,000%) higher than the area of the starting substrate, while maintaining the same mechanical strength and minimal (less than 0.03 times or 3%) increase in weight.

In one or more embodiments, a starting foam substrate having an estimated specific surface area less than 0.02 m²/g could be modified with carbon nanotubes to create a hierarchical structure characterized by a surface area in the range of about 2 to about 4 m^{2/}g.

In one or more embodiments, the hierarchical structures according to the present invention are characterized by the nanoparticles having a controlled particle size distribution from about 3 nm to about 8 nm. In yet other embodiments of the present invention, the hierarchical structures are characterized by the nanoparticles having a broad particle size distribution from about 5 nm to about 100 nm.

Qualitative failure analysis to determine the success of nanoscale attachment may be performed as follows. Samples broken at the edges are analyzed microscopically to evaluate if the nanotube attachments, resembling nanotube ‘forests’, are still attached. It has been observed in samples prepared according to the present invention that nanotubes remain attached, and fracture paths are indicated inside the graphite substrate itself rather than at the nanotube roots. This is defined as “strong bonding” of nanoscale attachments, when failure occurs in other parts of the substrate rather than at the intermediate layer wherein the nanoscale attachments are tethered to the substrate.

Another method useful in evaluating the success of nanotube attachment according to the present invention includes ultrasonification in water. The ultrasonification is believed to put large stresses at the base of the nanotube attachments since their high aspect ratio would magnify any force at the tips caused by moving water. Despite that, failures observed indicate that the entire top layer of substrate peels off like a carpet; however individual nanotubes (or nanoparticles attached to them) are not shed.

Yet another method to rapidly evaluate nanotube attachment is the Scotch Tape test. Samples according to the present invention demonstrate that about 95% of the surface remains unchanged, in other words nanoscale attachments are generally retained by the hierarchical structure. In the remaining about 5% area that does indicate loss of nanotubes, it has been observed that the entire outer substrate layer is removed like a carpet rather than as individual nanotubes. This thereby indicates failure occurring within the substrate itself and is a further indicator of strong attachment of nanotubes to the substrate via the intermediate layer.

Samples according to the present invention have also been tested by rotation in water. These hierarchical structures have been attached to bottles filled with water and subjected to prolonged rotations for days and weeks at 32 revolutions per minute. No visible changes in nanotube or metal nanoparticle density after long exposures to rotation in water were observed using electron microscopy imaging techniques.

Shown in FIG. 2 is a flow chart of a method that includes the following steps in fabricating a multiscale hierarchical structure according to the present invention. Step 20 includes selecting a substrate appropriate to the desired application. Step 22 includes modifying the substrate to form an intermediate layer using one or more surface modification techniques selected from the group (a) wet chemistry, (b) chemical vapor deposition, (c) plasma deposition, (d) atomic layer deposition, (e) physical vapor deposition, (f) controlled environment heating, or a combination thereof. Step 24 includes depositing or attaching at least one plurality of nanoscale attachments (nanotubes, nanoparticles, or combinations thereof) onto the intermediate layer, which may also be referred to as the coated substrate. The nanoscale attachments may be formed by using one or more techniques (a) through (f) described above or by combinations thereof. Step 26 includes optionally depositing or attaching a second plurality of nanoscale attachments (nanotubes, nanoparticles, or combinations thereof) onto the intermediate layer, the first plurality of nanoscale attachments, or to both the intermediate layer and the first plurality of nanoscale attachments. The nanoscale attachments may be formed by using one or more techniques (a) through (f) described above or by combinations thereof. Each of the steps 22, 24, and 26 may be optionally combined with heating in controlled environments such as in inert, oxidizing or reducing gases, or in vacuum as is known in the art.

The present invention is directed towards creation of hybrid hierarchical materials that consist of smaller nanoscale structures strongly tethered to larger solid substrates, and related methods of fabrication and use.

The hierarchical materials of the invention are useful in applications such as, but not limited to, the following:

(i) thermal and charge dissipation structures made from carbon nanotubes attached to larger substrates: carbon nanotubes, having high electrical and thermal conductivity, can be used, for example, as nano-radiators for electronic cooling, electromagnetic interference shielding, encapsulation of energy storage materials, and other applications;

(ii) core structure for composites: the fractal geometry of the surface provides more intimate bonding with the matrix, thereby improving toughness and durability;

(iii) scaffolding for biological growth;

(iv) catalysts for electrochemical reaction, hydrogen storage and water de-contamination, utilizing nanoparticles such as palladium;

(v) antimicrobial agents and sensors, utilizing nanoparticles such as gold and silver. Solid silver attached to an anchor has several advantages over chlorinated compounds and other common anti-bacterial chemicals that are directly dispersed in the water, spread in the environment, and consumed in food. In addition to other side effects, these chemicals appear to increase the development of antibiotic-resistant strains of bacteria. Solids of the present invention can significantly reduce the need for antibacterial chemicals in the water and directly address some of the above issues.

Various modifications and alterations that do not depart from the scope and spirit of this invention will become apparent to those skilled in the art. This invention is not to be duly limited to the illustrative embodiments set forth herein.

### EXAMPLES

### Example 1

### Carbon Nanotubes on Silica Coated Graphite

Base substrates used were flat graphite as well as microcellular foams of graphitic carbon. These were modified by coating with a silica nano-layer using microwave plasma deposition (MPD) of hexa-methyl-disiloxane (HMDSO) in O₂. Deposition of the oxide coating intermediate layer was accomplished in stages: (stage 1) O₂ (99.99%) gas introduced into the microwave plasma chamber to clean the surface; (stage 2) O₂ and HMDSO introduced at microwave power of 250 W; and (stage 3) O₂ carrier gas introduced to stabilize the oxide.

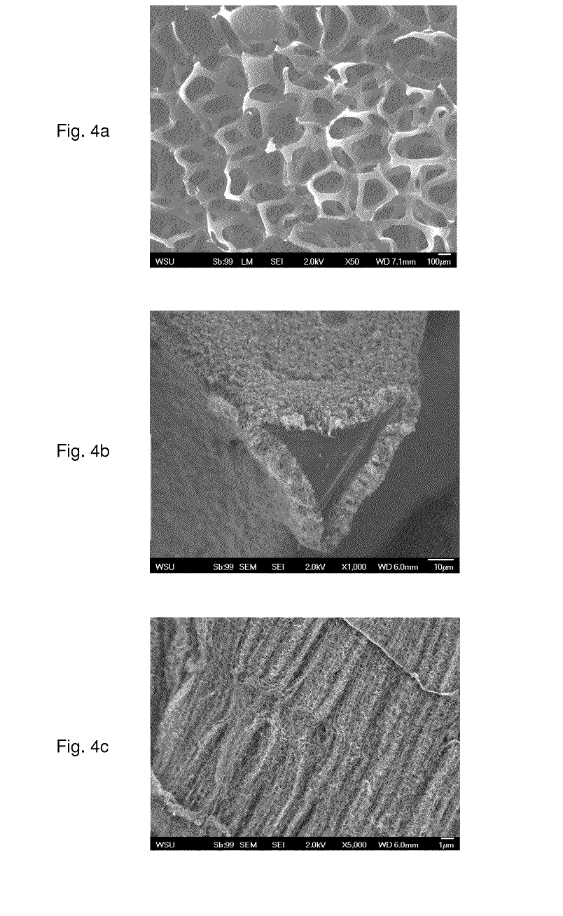

After silica layer deposition, samples were transferred to a CVD reactor for carbon nanotube (CNT) deposition. The CVD process parameters were optimized for purest nanotube growth. Optimization conditions depended upon the exact geometry of the substrate to be modified. The first stage of the CVD is used to heat the ferrocene/xylene solution prior to injection. The second stage of the CVD furnace is heated to the growth temperature for carbon nanotube fabrication (700-800° C.). Once samples were positioned in the reactor, a measured solution of ferrocene (C₁₀H₁₀Fe) dissolved in xylene (C₆H₄C₂H₆) was injected into a flowing gas mixture of argon and hydrogen. The substrates were heated to the growth temperature and subjected to deposition for specific times. After the allotted time, samples were allowed to cool in argon before removal from the CVD chamber. The deposition parameters for optimum nanotube morphology depended upon the initial geometry of the surface to be coated. FIG. 3 demonstrates a dense growth of carbon nanotubes is obtained on carbon foam as in this example using the surface modification technique of plasma pretreatment in combination with subsequent CVD deposition. The pretreatment level can be used to control the density of nanotubes grown on the surface, and the CVD process parameters can be adjusted for control of nanotube length and quality. FIG. 4 shows the growth of nanotubes using this method on reticulate carbon foam. FIG. 4a is the low magnification (50×) image of the foam as purchased. FIG. 4b (1,000×) shows that each strut can be covered with a dense carpet of nanotubes and FIG. 4c (5,000×) shows that the nanotube ‘forest’ can be very dense for long enough CVD times.

Semi-empirical predictions obtained by combining analytical modeling and micro-structural data indicate that it would be easy to obtain at least 100 times or more increase in surface area using the concepts of the present invention.

Direct specific surface area (SSA) measurements using the Brunauer-Emmett-Teller (BET) technique with nitrogen has been performed on cellular foam substrate material. It is seen that in commercial porous foams having a starting surface area of about 0.017 m²/g, the attachment of nanotubes results in a surface area of about 3 m²/g, implying an increase of well over 100-fold. Also significant, this occurs with negligible increase in volume and a weight gain of only about 2.5%. These advantages are anticipated to be significantly boosted for even longer grown nanotubes.

Thermal dissipation behavior of such structures into phase change materials has been tested and seen to be promising. The nanotube attachments are seen to increase the mechanical interlocking and prevent delamination between these solids and any matrix material, hence making them suitable for use in advanced composites.

These structures are also seen to offer accelerated growth of biological cells due to the scaffolding action of nanotubes on the surface. CNT-grafted foams show more prolific growth of healthy cells, which may result in faster bio-integration and healing of implants.

In addition to these advantages, at least one advantageous benefit of these hierarchical structures may come from the fact that the increased surface area can now harbor larger number of functional nanoparticles on its surface. FIG. 5 shows the schematic of the surface profile, indicating why a pore wall with attached nanotubes can support larger number of functional nanoparticles for applications such as catalysis, sensing, hydrogen storage, or antibacterial activity.

### Example 2

### CNT and PdNP on Graphitic Supports

Base structures tested were microcellular and reticulated carbon foam having uneven and irregular geometries as well as flat graphite substrates. Analytical reagents used, without further purification, are as follows: hexamethyl-di-siloxane (HMDSO), xylene, ferrocene, tetraamine palladium (II) nitrate solution (TAPN), methanol and concentrated nitric acid (HNO₃, 70%), and distilled water.

The as-received carbon foam substrate was modified, or pretreated, prior to attaching palladium nanoparticles by (1) nitric acid etching and (2) plasma assisted silica coating. Nitric acid etching was performed by immersing the carbon foam in 16M HNO₃ for a few minutes followed by sonication with distilled water to ensure complete removal of acid. Silica nanocoating was deposited onto the substrates in a microwave plasma reactor using HMDSO. The coating time was 15 minutes.

As an alternative to the above pre-treatments, some studies were also done on foam samples grafted with carbon nanotubes using the process discussed in Example 1. On all these samples, palladium nanoparticles (PdNP) were fabricated by liquid-phase synthesis technique followed by thermal reduction process. Tetraamine palladium nitrate (TAPN) was used as the metal precursor solution. Supports, cleaned with methanol and distilled water prior to infiltration, were immersed in the aqueous Pd precursor solution of tetraamine palladium (II) nitrate (TAPN) for specific period of time. The molar concentration used in this study was 62.5 mM TAPN and the supports were impregnated in the TAPN solution for 30 mins. The solid supports were recovered from the TAPN solution and the excess non-interacting solution on the sample was washed-by briefly dipping it in methanol. The samples were placed on a ceramic boat and immediately transferred to the furnace for heat treatment processing. Heat treatment may include several individual steps, or using a combination of steps such as: drying, calcining, and reducing. In one example, the impregnated samples were dried at 100° C. for 12 hrs in the ambient atmosphere to eliminate water from the samples. Calcination was then carried out in either oxygen-rich ambient atmosphere (air) or oxygen-deficient inert atmosphere (Ar). The thermal profile in this step was controlled with a ramp rate of 10° C/min and held at 450° C. for 2 hrs. This process of controlled heating was adapted to avoid sintering. The final step involved thermal gas-phase reduction of Pd oxides to metallic Pd. In this example, the temperature was increased to 500° C. and held for 2 hrs using hydrogen gas (25 cc/min) as a reducing agent in an inert atmosphere of Ar (500 cc/min), Ar/H₂:20/1. The furnace was then allowed to cool down to room temperature in the reduced flow of Ar and H₂. Surface morphology of metallic nanoparticles and hierarchical structures were observed using JEOL 7401F Field Emission Scanning Electron Microscopy (FESEM). Statistical analysis was carried out on SEM micrographs using Scandium© SEM imaging software for JEOL 7401F FESEM.

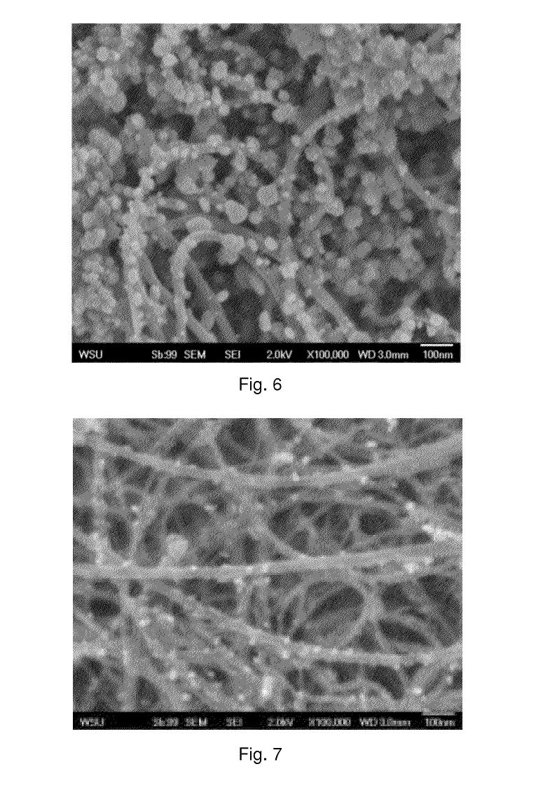

FIG. 6 demonstrates nanotubes attached to cellular carbon foam and subsequently functionalized with Pd nanoparticles.

### Example 3

### CNT and AgNP on Graphitic Supports

Several supports, or substrates, were tested for attachment of silver nanoparticles. They include (i) cellular carbon foam (ii) flat HOPG graphite (iii) carbon fibers and (iv) paper foils made of nanofibers, grapheme, and nanotubes.

Some of the samples were used “as-is”, while others were exposed to CVD to attach nanotubes as discussed in Example 1.

These structures were pre-wetted with methanol followed by dipping it in 0.24 M AgNO₃ solution for approximately for 1 hr. Samples were then placed on hot plate at 100° C. for 30 mins to remove moisture/water. These were finally reduced to metallic silver nanoparticles using the following process: DMSO has taken in a reduction beaker and a magnetic stirrer was placed at the bottom of the beaker. The sample was placed on a shelf above the stirrer. The reduction beaker was placed on a hot plate and heated to a temperature of from about 60° C. to about 80° C. followed by addition of 5 mg tri-sodium citrate. Continuous stirring helps rapid dissolution of citrate in DMSO. Silver nitrate coated sample was then placed on the sample shelf. After the desired time, samples were taken and washed off with distilled water and left to dry.

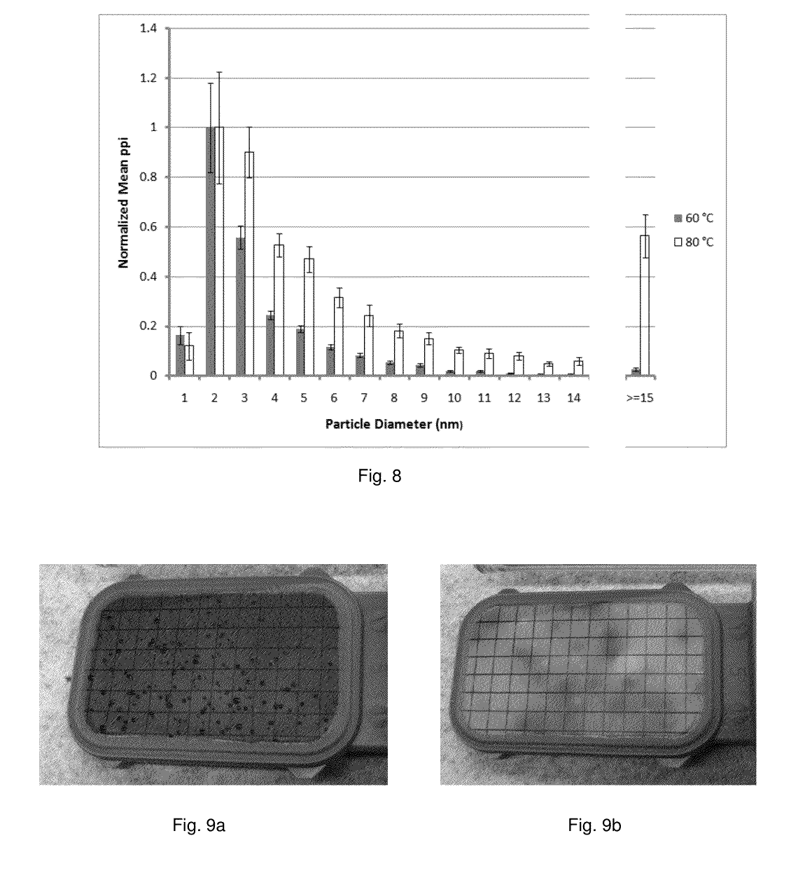

The particles were characterized using Field Emission SEM and detailed measurements of particle size distribution were made. FIG. 7 demonstrates nanotubes attached to carbon substrates, which are subsequently functionalized with silver nanoparticles (AgNP). FIG. 8 is an example of the particle distribution obtained for Ag nanoparticles obtained at two reduction temperatures. The distribution may also be altered to some extent with initial salt concentration.

The anti-bacterial activity of these structures is being measured with the idea of incorporating them into fluid purification systems. FIG. 9 shows the influence these materials have on lake water. FIG. 9a is the control, which shows a large number of bacterial colonies (dark spots) formed by incubation of untreated lake water. FIG. 9b shows results from identical testing performed on the lake water, after it was rotated in a 1-liter bottle containing 4 mm specimen of AgNP-decorated CNT-Foam support. The bacterial colonies are reduced drastically, or are non-existent.

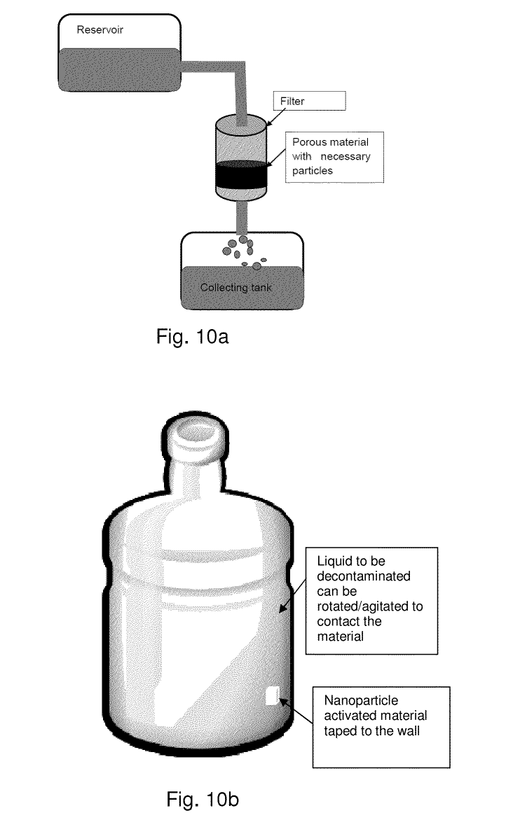

It is anticipated that the structures in this invention can be utilized in several different configurations for water purification, two of which have been tested successfully so far: flowing the contaminated water through the porous foam (as a filter shown in FIG. 10a), and rotation of Ag-NP decorated foam in 4000 times its volume of contaminated water (FIG. 10b).

What is claimed is:

1. A hierarchical structure characterized by ultrahigh surface area comprising:
a solid substrate;
an intermediate layer; and
at least one plurality of nanoscale attachments that are strongly bonded to the intermediate layer.

2. The hierarchical structure of claim 1 wherein the substrate further includes a substrate surface, wherein at least one aspect of the substrate surface is modified to enhance bonding.

3. The hierarchical structure of claim 1 wherein the intermediate layer is formed at the substrate surface.

4. The hierarchical structure of claim 1 wherein the structure is characterized by a specific surface area of at least about 100 times the specific surface area of the solid substrate.

5. The hierarchical structure of claim 1 wherein the solid substrate is compact or porous.

6. The hierarchical structure of claim 6 wherein the porous substrate comprises fibers, foams, sponges, fabric, paper, or combinations thereof.

7. The hierarchical structure of claim 1 wherein the substrate is inorganic or organic.

8. The hierarchical structure of claim 1 wherein the substrate comprises carbon, oxides, ceramics, glasses, polymers, or combinations thereof.

9. The hierarchical structure of claim 6 wherein the porous substrate is derived from plant, animal, or geological sources.

10. The hierarchical structure of claim 1 wherein the nanoscale attachments comprise nanotubes, nanoparticles, or combinations thereof.

11. The hierarchical structure of claim 10 wherein the nanotubes are cylindrical structures with diameters ranging from about 10 to about 50 nm and aspect ratios ranging from about 10 to about 100,000.

12. The hierarchical structure of claim 10 wherein the nanotubes are useful for guiding cell growth and for efficient thermal and electrical transport with the surrounding media.

13. The hierarchical structure of claim 10 wherein the nanoparticles comprise metals or compounds with surface-active properties suitable for catalysis, sensing, bioactivity, or antibacterial effect.

14. The hierarchical structure of claim 10 wherein the nanoparticles have a controlled particle size distribution from about 3 nm to about 8 nm.

15. The hierarchical structure of claim 10 wherein the nanoparticles have a broad particle size distribution from about 5 nm to about 100 nm.

16. The hierarchical structure of claim 10 wherein the nanoparticles are elements, compounds, or combinations thereof.

17. The hierarchical structure in claim 1 wherein the structure is used for water purification.

18. The hierarchical structure of claim 1 wherein the structure is used for sensing and remedial treatment of gases or fluids.

19. A method of fabricating a hierarchical structure comprising:
selecting and preparing a parent substrate, wherein the preparing may optionally include cleaning or activation;
modifying the substrate surface to form an intermediate layer;
attaching at least one plurality of nanoscale attachments, wherein the nanoscale attachments are selected from nanotubes, nanoparticles, or combinations thereof, onto the intermediate layer;
optionally attaching a second plurality of nanoscale attachments, wherein the nanoscale attachments are selected from nanotubes, nanoparticles, or combinations thereof, onto the first plurality of nanoscale attachments and intermediate layer;
wherein the steps of forming the intermediate layer and attaching the nanoscale attachments use one or more surface modification techniques selected from the group (a) wet chemistry, (b) chemical vapor deposition, (c) plasma deposition, (d) atomic layer deposition, (e) physical vapor deposition, (f) controlled environment heating, or a combination thereof; and
optionally heating in a controlled environment.
